(19) United States
(12) Patent Application Publication
(10) Pub. No.: US 2007/0127943 A1
(43) Pub. Date: Jun. 7, 2007

(54) Image forming system

(75) Inventor: Tsuyoshi Kowari, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Shinjuku-ku (JP)

(21) Appl. No.: 11/602,427

(22) Filed: Nov. 20, 2006

(30) Foreign Application Priority Data
Nov. 24, 2005 (JP) 2005-338390
Nov. 24, 2005 (JP) 2005-338399

(51) Int. Cl. G03G 15/00

(52) U.S. Cl. 399/88

(57) ABSTRACT

An image forming system includes a first device having a power unit that generates a drive voltage and an image forming portion, and a second device for controlling the image forming portion. The power unit generates a first drive voltage as the drive voltage and a second drive voltage higher than the first drive voltage, and the second device includes a voltage supply control portion that controls whether or not the second drive voltage is supplied to the second device.

### CROSS-REFERENCES

The present application incorporates the contents of Japanese patent application 2005-338390 and Japanese patent application 2005-338299 filed on 24 Nov. 2005.

### BACKGROUND

The present invention relates to image forming systems.

A conventional input-output device is disclosed in JP-A-6-233016. This conventional input-output device has a scanner portion and a printer portion, and driving power is supplied to the scanner portion and the printer portion respectively by different power circuits, and further still a control power is supplied by another power circuit.

However, with this conventional input-output device, because power circuits must be provided to the scanner portion and the printer portion respectively, there is a problem that this increases the size of devices and involves higher costs. Furthermore, in input-output devices having a scanner portion and a printer portion, it is important to suppress power consumption and prevent damage caused by shorts.

### SUMMARY

An image forming system according to an embodiment of the present invention includes:

a first device having a power unit that generates a drive voltage and an image forming portion; and

a second device for controlling the image forming portion,

wherein the power unit generates a first drive voltage as the drive voltage and a second drive voltage higher than the first drive voltage, and

the second device includes a voltage supply control portion that controls whether or not the second drive voltage is supplied to the second device.

An image forming system according to another embodiment of the present invention includes:

a first device having a power unit that generates a drive voltage and an image forming portion;

a second device for controlling the image forming portion; and

a power supply member that is provided capable of being attached and unattached to the first and second devices, and supplies the drive voltage from the first device to the second device,

wherein the power unit generates a first drive voltage as the drive voltage and a second drive voltage higher than the first drive voltage,

supply of the first drive voltage to the second device is controlled based on a state of attachment or detachment of the power supply member to or from the first device or the second device, and

supply of the second drive voltage to the second device is controlled based on a state of attachment or detachment of the power supply member to or from the first device or the second device and a voltage supply control portion provided in the second device.

### DESCRIPTION OF DRAWINGS

FIG. 1 is a block diagram illustrating an embodiment of an image forming system according to the present invention.

FIG. 2 shows a part of a circuit configuration of the image forming system according to an present embodiment of the present invention.

FIG. 3 is a flowchart illustrating one example of an operation of the image forming system according to an embodiment of the present invention.

FIG. 4 is a flowchart illustrating one example of an operation of the image forming system according to an embodiment of the present invention.

### DETAILED DESCRIPTION

One object of the present invention is to provide an image forming system capable of achieving miniaturization and stable operation and capable of suppressing power consumption.

Furthermore, another object of the present invention is to provide an image forming system capable of achieving miniaturization and in which damage caused by shorts or the like is reduced.

(1) An image forming system according to one aspect of the present embodiment includes:

a first device having a power unit that generates a drive voltage and an image forming portion, and

a second device for controlling the image forming portion,

wherein the power unit generates a first drive voltage as the drive voltage and a second drive voltage higher than the first drive voltage, and

the second device includes a voltage supply control portion that controls whether or not the second drive voltage is supplied to the second device.

With this configuration, the power unit that supplies the first and second devices is arranged in the first device and therefore it is possible to provide an image forming system that is smaller and lower in cost than when providing power units in both the first and second devices.

Furthermore, with this configuration, the second device conducts independent control of the second drive voltage that is supplied to this second device, and therefore the load on the first device is reduced and it is possible to achieve large reductions in the overall power consumption of the image forming system.

(2) In the above-described image forming system,

the first device may further include a voltage supply control portion that controls whether or not the second drive voltage is supplied to the image forming portion.

With this configuration, the first device conducts independent control of the second drive voltage that is supplied to this first device and therefore the load on the second device is reduced and it is possible to achieve large reductions in the overall power consumption of the image forming system.

(3) An image forming system according to another embodiment of the present invention includes:

a first device having a power unit that generates a drive voltage and an image forming portion,

a second device for controlling the image forming portion, and

a power supply member that is provided capable of being attached and unattached to the first and second devices, and supplies the drive voltage from the first device to the second device,

wherein the power unit generates a first drive voltage as the drive voltage and a second drive voltage higher than the first drive voltage,

supply of the first drive voltage to the second device is controlled based on a state of attachment or detachment of the power supply member to or from the first device or the second device, and

supply of the second drive voltage to the second device is controlled based on a state of attachment or detachment of the power supply member to or from the first device or the second device and a voltage supply control portion provided in the second device.

With this configuration, the power unit that supplies the first and second devices is arranged in the first device and therefore it is possible to provide an image forming system that is smaller and lower in cost than when providing power units in both the first and second devices.

Also, with this configuration, when the power supply member is disconnected from the first device and/or the second device, the supply of the drive voltage to the power supply member can be stopped. For this reason, it is possible to avoid the drive voltage being supplied to the power supply member when the power supply member is in a state disconnected from the first device and/or the second device as well as the power supply member being connected to the first device and/or the second device while being supplied with the drive voltage. Moreover, with this configuration, the second drive voltage is controlled based on the voltage supply control portion of the second device and therefore supply of the second drive voltage can be stopped when a part of the second device is not operating normally for example. Consequently, with this configuration, it is possible to provide an image forming system that suffers little damage due to shorts or the like.

(4) In the above-described image forming system,

supply of the second drive voltage to the image forming portion may be controlled based on a voltage supply control portion provided in the first device.

With this configuration, the first device conducts independent control of the second drive voltage that is supplied to this first device and therefore the load on the second device is reduced and it is possible to achieve large reductions in the overall power consumption of the image forming system.

(5) In the above-described image forming system,

supply of the second drive voltage to the second device may be carried out after the second drive voltage has been supplied to the image forming portion.

With this configuration, since the timing by which the first device is driven and the timing by which the second device is driven can be shifted, it is possible to achieve stable operations of the image forming system.

(6) In the above-described image forming system,

supply of the second drive voltage to the second device may be carried out after the first drive voltage has been supplied to the second device.

With this configuration, for example, a low voltage for control is supplied first, followed by the supply of a high voltage for driving. Consequently, the image forming system can be recovered very stably.

(7) In the above-described image forming system,

supply of the second drive voltage to the second device may be carried out after an operational status of the second device has been confirmed.

With this configuration, supply of the second drive voltage can be stopped for example when the second device is not operating or is malfunctioning. Consequently, the image forming system can be operated very stably.

(8) In the above-described image forming system,

the second device may further include an image input portion.

Hereinafter, embodiments of the present invention are described with reference to the accompanying drawings.

1. Outline of Image Forming System

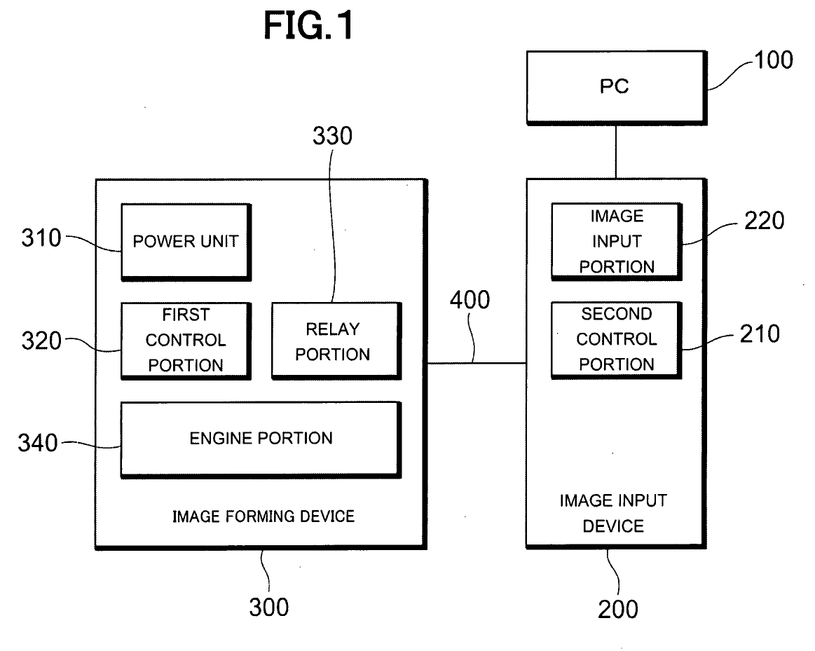

FIG. 1 is a block diagram illustrating an embodiment of an image forming system according to the present invention. The image forming system is provided with a host computer 100, which is an external device, an image forming device 300, which is a first device example, an image input device (or an image reading device) 200, which is a second device example, and a cable 400, which is an example of a power supply portion. In the image forming system of the present embodiment, the image forming device 300, which carries out printing processes and the like on a medium, is connected via the image input device 200 and the cable 400 to the host computer 100, which is operated by a user.

Based on instructions received from the user, the host computer 100 carries out instructions with respect to the image input device 200 so that the image forming device 300 and/or the image input device 200 is made to carry out predetermined processes.

The image forming device 300 is a printer for example and is configured having a power unit 310, a first control portion 320, an engine portion 340, and a relay portion 330. The engine portion.340 is an example of an image forming portion.

The image input device 200 is a scanner for example and is configured having a second control portion 210 and an image input portion 220. Based on instructions received from the host computer 100, the second control portion 210 controls operations of the image input device 200 and the image forming device 300. The image input portion 220 recognizes an image written on a medium or the like that has been placed in the image input portion 220, then converts the recognized image into data and supplies the data to the host computer 100 and/or the image forming device 300.

The power unit 310 receives an AC voltage from a commercial power source and generates a drive voltage for driving the image input device 200 and the image forming device 300. The drive voltage generated by the power unit 310 is supplied to the image input device 200 via the cable 400, which is an example of a power supply member.

Based on instructions from the second control portion 210 of the image input device 200, the first control portion 320 controls various configurations contained in the engine portion 340. The engine portion 340 is configured having structures necessary for forming an image on the medium that is placed in the image forming device 300, these structures including a photosensitive structure drive motor unit, an overall drive motor unit, a secondary transfer rolling connecting clutch, an intermediate transfer belt cleaner connecting clutch, a development drive motor unit, a rotary drive motor unit, an eraser lamp unit, an ozone fan unit, a toner fan unit, a cooling fan, a paper supply related clutch, and a scanner motor for example.

The relay portion 330 performs relay between the power unit 310 and the first control portion 320 and the cable 400. Specifically, the relay portion 330 supplies drive voltage generated by the power unit 310 to the cable 400, and supplies the various signals generated by the second control portion 210 to the first control portion 320.

The cable 400 connects the image input device 200 and the image forming device 300. The cable 400 is arranged detachably to the image input device 200 and the image forming device 300. Furthermore, the cable 400 is constituted by a plurality of signal lines, and the signal lines supply the drive voltage generated by the power unit 310 to the image input device 200 and supplies various signals from the image input device 200 to the image forming device 300 or from the image forming device 300 to the image input device 200.

In the image forming system of the present embodiment, when the cable 400 is separated from at least one of the image input device 200 and the image forming device 300 (when unplugged for example), supply of drive voltage to the image input device 200 stops and therefore operation of the image input device 200 stops. Accompanying this, instructions and the like from the second control portion 210 also stop being supplied to the image forming device 300.

2. Circuit Configuration of the Image Forming System

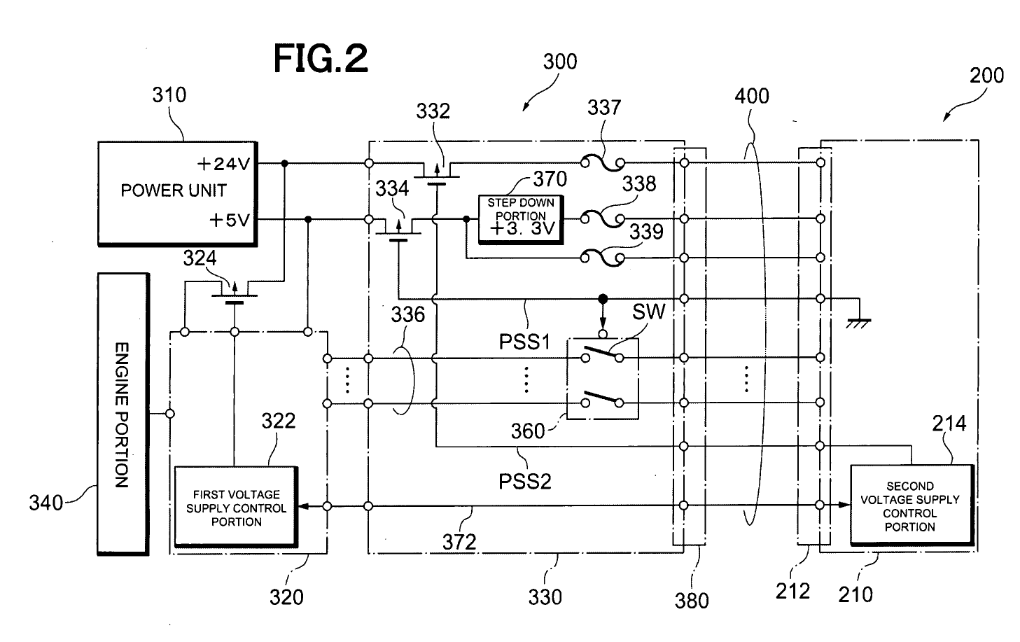

Next, description is given concerning a circuit configuration of the image forming system according to the present embodiment. FIG. 2 shows one example of the circuit configuration of the image forming system according to the present embodiment.

The power unit 310 receives an AC voltage from a commercial power source and based on unshown control signals, generates a first drive voltage (+5V in the present example) and a second drive voltage higher than that (+24V in the present example) as drive voltages for driving the image input device 200 and the image forming device 300. Then, of the first and second drive voltages, one is supplied to the first control portion 320 and the other is supplied to the second control portion 210 via the relay portion 330.

In more detail, of the drive voltages generated by the power unit 310, whether or not the second drive voltage (+24V) is supplied to the first control portion 320 (finally to the engine portion 340) is controlled according to a first voltage supply control portion 322 of the image forming device 300. Specifically, a FET 324 is arranged between the power unit 310 and the first control portion 320, and with the FET 324, a source enabling supply of the second drive voltage is connected to the power unit 310, a drain is connected to the first control portion 320, and a gate is connected to the first voltage supply control portion 322. Also, with the FET 324, the gate is turned on and off based on a voltage supplied from the first voltage supply control portion 322, thereby controlling whether or not the second drive voltage is supplied to the first control portion 320. It should be noted that the first voltage supply control portion 322 may be provided as a part of the first control portion 320 as shown in FIG. 2 or may be provided separate to the first control portion 320. Furthermore, the FET 324 may be provided separate to the first control portion 320 as shown in FIG. 2 or may be provided as a part of the first control portion 320. It should be noted that in the example shown in FIG. 2, the FET 324 is a p-channel MOS transistor.

The relay portion 330 includes FETs 332 and 334, a plurality of signal lines 336, fuses 337, 338, and 339, a signal buffer 360, and a connector 380. The FETs 332 and 334 are p-channel MOS transistors in the example shown in FIG. 2.

The second control portion 210 of the image input device 200 is configured having a connector 212 to which the cable 400 can be attached and detached, and carries out reception and transmission of various signals and drive voltages with the relay portion 330 via the cable 400 and the connector 212.

Whether or not the first drive voltage (+5V) generated by the power unit 310 is supplied to the second control portion 210 is controlled based on the attached/detached condition of the cable 400. Specifically, the FET 334 is arranged between the power unit 310 and the second control portion 210, and with the FET 334, the source enabling supply of the first drive voltage is connected to the power unit 310, the drain is connected to the connector 380, and the gate is connected to a signal line PSS1. The signal line PSS1 is pulled up by the +5V to connect to the connector 380 and the image input device 200 is grounded via the cable 400 and the connector 212. That is, when the cable 400 is connected to both the connectors 380 and 212, the signal line PSS1 is grounded and its voltage becomes 0V, and when the cable 400 is separated from at least one of the connectors 380 and 212, the voltage comes +5V Consequently, with the FET 334, when the cable 400 is connected to both the connectors 380 and 212, the gate voltage becomes 0V (L logic) and is ON, and as a result, the first drive voltage is supplied to the second control portion 210 (the image input device 200) via the relay portion 330 and the cable 400. On the other hand, when the cable 400 is separated from at least one of the connectors 380 and 212, the gate voltage becomes +5V (H logic) and is OFF, and as a result, drive voltage is stopped being supplied to the connector 380, the cable 400 and the second control portion 210 (image input device 200).

In the example shown in FIG. 2, one end of the drain of the FET 334 is connected to the second control portion 210 so as to be capable of supplying the first drive voltage via the fuse 339, and the other end is connected to the second control portion 210 so as to be capable of supplying the post step down drive voltage (+3.3V in the present example) via the step down portion 370 and the fuse 338. The +3.3V is supplied to the second control portion 210 (the image input device 200) via the cable 400 when the cable 400 is connected to both the connectors 380 and 212. It should be noted that the step down portion 370 in the example shown in FIG. 2 is provided on a relay portion 330 (image forming device 300) side, but as a modified example it may also be provided on a second control portion 210 (image input device 200) side.

Whether or not the second drive voltage (+24V) generated by the power unit 310 is supplied to the second control portion 210 is controlled according to the attached/detached condition of the cable 400 and the second voltage supply control portion 214 provided in the image input device 200. Specifically, the FET 332 is arranged between the power unit 310 and the second control portion 210, and with the FET 332, the source enabling supply of the second drive voltage is connected to the power unit 310, the drain is connected to the connector 380 via the fuse 337, and the gate is connected to the second voltage supply control portion 214 via the cable 400. A signal line PSS2 is pulled up by the +5V to connect to the connector 380 and to connect to the second control portion 210 via the cable 400 and the connector 212. Then, with the FET 332, when the cable 400 is connected to both the connectors 380 and 212, the gate is turned ON and OFF according to the voltage supplied from the second voltage supply control portion 214 thereby controlling whether or not the second drive voltage is supplied to the second control portion 210. On the other hand, when the cable 400 is separated from at least one of the connectors 380 and 212, the gate voltage becomes +24V (H logic) and is OFF, and as a result, drive voltage is stopped being supplied to the connector 380, the cable 400, and the second control portion 210 (image input device 200). It should be noted that the second voltage supply control portion 214 may be provided as a part of the second control portion 210 as shown in FIG. 2 or may be provided separate to the second control portion 210.

The signal buffer 360 is configured having a plurality of signal lines 336 and a plurality of switches SW. When OFF, the switches SW are such that the there-connected wires have high impedance. The plurality of switches SW are controlled in response to the voltage of the signal lines PSS. Specifically, the plurality of switches SW are configured to be OFF when the voltage of the signal lines PSS is +5V (H logic) and ON when this voltage is 0V (L logic). That is, the plurality of signal lines 336 have high impedance when the cable 400 is separated from at least one of the connectors 380 and 212, but when the cable 400 is connected to both the connectors 380 and 212, it is connected to the second control portion 210 via the cable 400.

In the example shown in FIG. 2, a dedicated line 372 is provided between the first and second voltage supply control portions 322 and 214. This enables control of the first and second voltage supply control portions 322 and 214 to be synchronized. For example, after the first voltage supply control portion 322 turns ON the FET 324, a signal indicating this ON condition is sent from the first voltage supply control portion 322 to the second voltage supply control portion 214 via the dedicated line 372, then after this signal is confirmed, the second voltage supply control portion 214 can turn ON the FET 332. For this reason, for example, a timing by which the second drive voltage is supplied to the engine portion 340 can be intentionally shifted from a timing by which the second drive voltage is supplied to the image input device 200. Consequently, the starting timings of both the image forming device 300 and the image input device 200 can be kept from matching, thereby enabling stable operation of the image forming system.

It should be noted that in the image forming system of the present embodiment, the second drive voltage (+24V) is mainly used as a drive power for driving mechanisms that constitute the image forming system, and the first drive voltage (+5V) and the other drive voltage (+3.3V) are mainly used as control power for driving configurations that control the mechanisms.

Furthermore, in the above-described configuration, the FETs 324, 332, and 334 are shown in an example as p-channel MOS transistors, but it is also possible to apply n-channel MOS transistors. In this case, control is conducted such that the H logic and the L logic are reversed for the ON and OFF of the FETs. Moreover, the FETs 324, 332, and 334 are an example of a switching element, but as long as the ON/OFF operation is switchable, there is no limitation to FETs.

3. Operation of Image Forming System

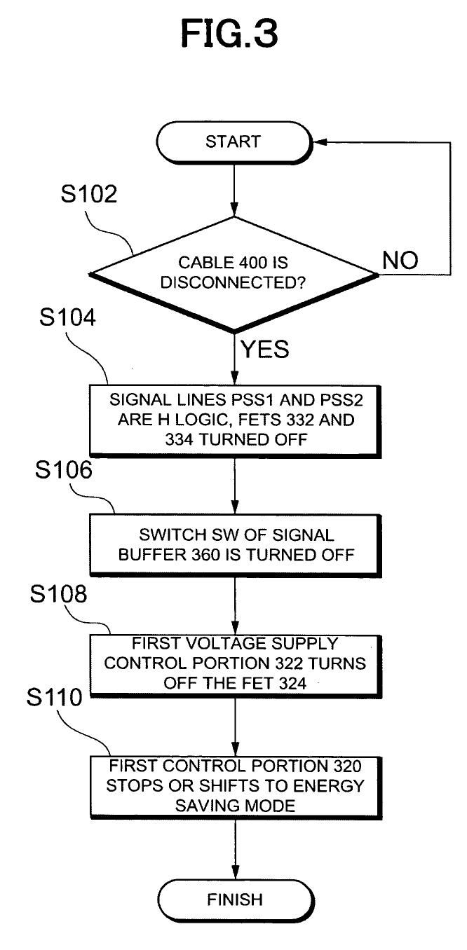

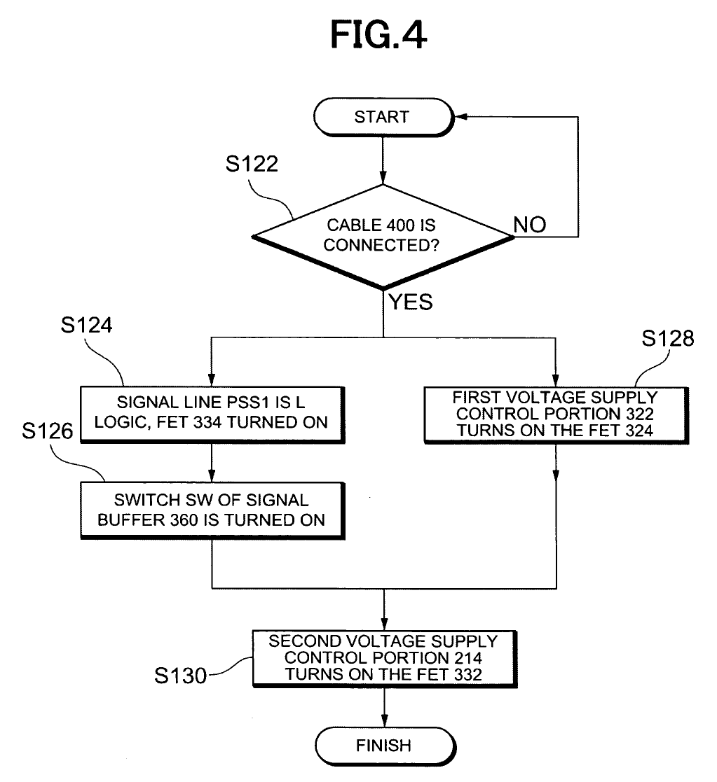

Next, description is given of an example of operation of the image forming system according to the present embodiment. FIG. 3 is a flowchart for describing an operation of the image forming system when the cable is separated, and FIG. 4 is a flowchart for describing an operation of the image forming system when the cable is connected.

(3-1) As shown in FIGS. 2 and 3, when the cable 400 is connected to both the connectors 380 and 212 (NO at S102), that is, when the image input device 200 and the image forming device 300 are connected to each other, the image forming device 300 is capable of supplying power to the image input device 200 and these are communicable with each other.

Specifically, in this case, the signal line PSS1 is grounded in the image input device 200 via the cable 400 thereby turning ON the FET 334 and therefore the first drive voltage (+5V) generated by the power unit 310 is supplied to the image input device 200 via the cable 400. Furthermore, the +3.3V that has been stepped down by the step down unit 370 is also supplied to the image input device 200 via the cable 400. Furthermore, the switch SW is turned ON due to the signal line PSS1 being grounded, such that the plurality of signal lines 336 are grounded in the second control portion 210. This enables the image input device 200 and the image forming device 300 to carry out communication of receiving and transmitted instructions and various data. Further still, when the second voltage supply control portion 214 has turned ON the FET 332 (that is, inputting L logic to the gate), the second drive voltage (+24V) generated by the power unit 310 is also supplied to the image input device 200 via the cable 400.

As shown in FIGS. 2 and 3, when the cable 400 detaches from at least one the connectors 380 and 212 (YES at S102), that is, when the image input device 200 and the image forming device 300 are detached from each other, the image forming device 300 stops supplying power to the image input device 200 and communication between these devices is cut.

Specifically, in this case, the signal line PSS1 changes from a state in which it was grounded via the cable 400 to become pulled up by the +5V due to the cable 400 being disconnected. When the voltage of the signal line PSS1 changes to +5V, the FET 334 is turned ON (S104) by the gate voltage becoming +5V (H logic). In this way, the first drive voltage (+5V) and the stepped down voltage (+3.3V) are no longer supplied to the connector 380. Furthermore, in the same manner, the signal line PSS2 is pulled up by the +5V due to the cable 400 being disconnected, such that the FET 332 is turned ON (S104) by the gate voltage becoming +5V (H logic), and the second drive voltage (+24V) also stops being supplied to the connector 380. Consequently, it is possible to avoid damage to the various structures of the image forming device 300 due to shorts and the like.

Furthermore, when the voltage of the signal line PSS1 becomes +5V (H logic), the switch SW of the signal buffer 360 is turned ON (S106) such that communication between the image input device 200 and the image forming device 300 using the plurality of signal lines 336 is cut.

Furthermore, when the cable 400 becomes disconnected from at least one of the connectors 380 and 212 the first voltage supply control portion 322 turns ON the FET 324 such that supply of the second drive voltage (+24V) to the first control portion 320 (and to the engine portion 340) is stopped (S108). The turning ON and OFF of the FET 324 may be controlled for example based on the state of connection between the first and second voltage supply control portions 322 and 214 (for example, state of connection to the dedicated line 372). When supply of the second drive voltage (+24V) stops, the operation of the first control portion 320 stops (S110) and the engine portion 340 also stops operating. Or the first control portion 320 can be shifted to an energy saving mode (S110) by stopping supply of the second drive voltage (+24V). The operation of the engine portion 340 is stopped when the first control portion 320 goes into the energy saving mode.

Thus, when the cable 400 disconnects from at least one of the connectors 380 and 212, the power unit 310 stops supply of the second drive voltage (+24V) and the first drive voltage (+5V) is supplied to the first control portion 320. In this way, damage to the image forming system due to shorts can be prevented.

(3-2) Next, description is given with reference to FIG. 4 concerning an operation in which the cable 400 is connected to both the connectors 380 and 212 to recover the image forming system. It should be noted that the description here concerns a case in which the image forming system is operating both the image input device 200 and the image forming device 300 in normal mode.

Here “normal mode” refers to when the mechanisms constituting the image forming system and the control circuits for controlling these mechanisms are both operated, and in contrast to this “energy saving mode” refers to when only the control circuits for controlling the mechanisms constituting the image forming system are operated.

First, when the cable 400 is connected to both the connectors 380 and 212 (YES at S122), the signal line PSS1 is grounded via the cable 400 and the voltage thereof becomes 0V When the signal line PSS1 becomes 0V, the FET 334 is turned ON by the gate voltage being 0V (L logic) and the first drive voltage (+5V) is supplied (S124) to the second control portion 210 via the cable 400. Additionally, the voltage (+3.3V) stepped down by the step down unit 370 is also supplied to the second control portion 210 via the cable 400.

Furthermore, when the signal line PSS1 becomes 0V, the switch SW of the signal buffer 360 is turned ON (S126). This connects the plurality of signal lines 336 between the first and second control units 320 and 210 and enables the image input device 200 and the image forming device 300 to carry out communication of receiving and transmitted instructions and various data.

On the other hand, the first voltage supply control portion 322 turns ON the FET 324 and the second drive voltage (+24V) is supplied (S128) to the first control portion 320 (or the engine portion 340). Supply of the second drive voltage to the first control portion 320 can be carried out substantially simultaneous to the supply of the first drive voltage to the second control portion 210 or may be carried out shifted before or after it.

Then, the second voltage supply control portion 214 sets the voltage of the signal line PSS2 to 0V (L logic) to turn ON the FET 332, and the second drive voltage (+24V) is supplied (S130) to the second control portion 210 via the cable 400.

In the example shown in FIG. 4, the supply of the second drive voltage (+24V) to the second control portion 210 is carried out after the second drive voltage has been supplied to the first control portion 320. For example, a time from the point at which the cable 400 connects to both the connectors 380 and 212 until the second drive voltage (+24V) is supplied may be set in advance such that it is different for the first and second voltage supply control portions 322 and 214 respectively. Alternatively, control may be performed intentionally using the dedicated line 372 that enables communication between the first and second voltage supply control portions 322 and 214 so as to shift the timings of voltage supply. This enables the timing by which image forming device 300 is driven and the timing by which the image input device 200 is driven to be shifted and therefore the image forming system can be operated stably.

Moreover, in the example shown in FIG. 4, the supply of the second drive voltage (+24V) to the second control portion 210 is carried out after the first drive voltage (+5V) has been supplied to the second control portion 210. For example, in the second voltage supply control portion 214, when the cable 400 is connected to both the connectors 380 and 212 and a fixed time has elapsed since the supply of the first drive voltage (+5V) to the second control portion 210, the FET 332 may be turned ON. This enables a low voltage for control to be supplied to the second control portion 210 first and then followed by the supply of a high voltage for driving. Consequently, the image forming system can be recovered very stably.

It should be noted that supply of the second drive voltage (+24V) to the second control portion 210 may be carried out after the operational status of the image input device 200 (for example, the second control portion 210) has been confirmed (when regular operation has been confirmed for example). This enables supply of the second drive voltage (+24V) to be stopped when the image input device 200 is not operating or is malfunctioning.

Thus, when the cable 400 is connected to both the connectors 380 and 212, the first and second drive voltages can be supplied stably to the image forming device 300 and the image input device 200.

(3-3) Next, description is given concerning operation of the image input device 200 the image forming device 300 when the cable 400 is connected to both the connectors 380 and 212.

When the image input device 200 and the image forming device 300 are in energy saving mode, the first drive voltage (+5V) is supplied to the first control portion 320 on the one hand, and supplied to the second control portion 210 via the FET 334 and the cable 400 on the other hand. It should be noted that the signal line PSS1 is grounded by connection to the cable 400 to turn ON the switch SW, thereby enabling communication between the image input device 200 and the image forming device 300 using the plurality of signal lines 336.

First, when the image forming device 300 recovers from the energy saving mode to the normal mode, the first voltage supply control portion 322 turns ON the FET 324 and the second drive voltage (+24V) is supplied to the first control portion 320. In this case, if necessary, the first voltage supply control portion 322 may communicate with the second voltage supply control portion 214 via the dedicated line 372. For example, after it has been confirmed that the second voltage supply control portion 214 has turned OFF the FET 332, the first voltage supply control portion 322 may turn ON the FET 324.

Also, when the image input device 200 recovers from the energy saving mode to the normal mode, the second voltage supply control portion 214 turns ON the FET 334 and the second drive voltage (+24V) is supplied to the second control portion 210. In this case, if necessary, the second voltage supply control portion 214 may communicate with the first voltage supply control portion 322 via the dedicated line 372. For example, when the image forming device 300 recovers to normal mode at the same time, the first voltage supply control portion 322 turns on the FET 324 and then after a predetermined time has elapsed, the second voltage supply control portion 214 may turn ON the FET 332.

It should be noted that after the second voltage supply control portion 214 has confirmed (by confirming regular operation for example) the operational status of the image input device 200 (for example, the second control portion 210), supply of the second drive voltage (+24V) may be carried out. This enables supply of the second drive voltage (+24V) to be stopped when the image input device 200 is not operating or is malfunctioning.

Furthermore, when the image forming device 300 shifts from normal mode to energy saving mode, the first voltage supply control portion 322 turns OFF the FET 324. This stops supply of the second drive voltage (+24V) to the first control portion 320. Consequently, only the first drive voltage (+5V) from the power unit 310 is supplied to the first control portion 320 and operation of mechanisms including the engine portion 340 is stopped while only the control circuits for controlling these mechanisms are made to operate.

Furthermore, when the image input device 200 shifts from normal mode to energy saving mode, the second voltage supply control portion 214 turns OFF the FET 334. This stops supply of the second drive voltage (+24V) to the second control portion 210. Consequently, only the first drive voltage (+5V) from the power unit 310 is supplied to the second control portion 320 and operation of mechanisms (for example mechanisms involved in FAX transmissions, network scanning, and the like) is stopped while only the control circuits for controlling these mechanisms are made to operate.

With the above-described configuration, whether or not the second drive voltage (+24V) is supplied to the image input device 200 is controlled by the image input device 200 itself, and therefore whether or not voltage is supplied can be determined based on the operational status of the image input device 200. That is, when the image input device 200 is not operating or is malfunctioning, the second drive voltage (+24V) can be set so as to not be supplied for example. Consequently, it is possible to avoid the supply of high voltage in a non-control condition, which enables damage due to shorts and the like to be reduced. Moreover, the second drive voltage (+24V) supplied to the image input device 200 is subjected to independent control by the image input device 200 itself, and therefore it is possible to achieve reductions in the load on the image forming device 300 and the overall power consumption of the image forming system can be greatly reduced.

Detailed description has been given herein concerning embodiments of the present invention but it will be readily understood by a person skilled in the art that many modified examples are possible that do not substantially deviate from the new matter and effects of the present invention. Accordingly, all such modified examples are included within the scope of the present invention.

What is claimed is:

1. An image forming system comprising:
a first device having a power unit that generates a drive voltage and an image forming portion; and
a second device for controlling the image forming portion,
wherein the power unit generates a first drive voltage as the drive voltage and a second drive voltage higher than the first drive voltage, and
the second device includes a voltage supply control portion that controls whether or not the second drive voltage is supplied to the second device.

2. The image forming system according to claim 1,
wherein the first device further comprises a voltage supply control portion that controls whether or not the second drive voltage is supplied to the image forming portion.

3. The image forming system according to claim 1,
wherein supply of the second drive voltage to the second device is carried out after the second drive voltage has been supplied to the image forming portion.

4. The image forming system according to claim 1,
wherein supply of the second drive voltage to the second device is carried out after the first drive voltage has been supplied to the second device.

5. The image forming system according to claim 1,
wherein supply of the second drive voltage to the second device is carried out after an operational status of the second device has been confirmed.

6. The image forming system according to claim 1,
wherein the second device further comprises an image input portion.

7. An image forming system comprising:
a first device having a power unit that generates a drive voltage and an image forming portion;
a second device for controlling the image forming portion; and
a power supply member that is provided capable of being attached and unattached to the first and second devices, and supplies the drive voltage from the first device to the second device,
wherein the power unit generates a first drive voltage as the drive voltage and a second drive voltage higher than the first drive voltage,
supply of the first drive voltage to the second device is controlled based on a state of attachment or detachment of the power supply member to or from the first device or the second device, and
supply of the second drive voltage to the second device is controlled based on a state of attachment or detachment of the power supply member to or from the first device or the second device and a voltage supply control portion provided in the second device.

8. The image forming system according to claim 7,
wherein supply of the second drive voltage to the image forming portion is controlled based on a voltage supply control portion provided in the first device.

9. The image forming system according to claim 7,
wherein supply of the second drive voltage to the second device is carried out after the second drive voltage has been supplied to the image forming portion.

10. The image forming system according to claim 7,
wherein supply of the second drive voltage to the second device is carried out after the first drive voltage has been supplied to the second device.

11. The image forming system according to claim 7,
wherein supply of the second drive voltage to the second device is carried out after an operational status of the second device has been confirmed.

12. The image forming system according to claim 7,
wherein the second device further comprises an image input portion.
